(19) United States
(12) Patent Application Publication
(10) Pub. No.: US 2025/0114804 A1
(43) Pub. Date: Apr. 10, 2025

(54) NOZZLE ARRANGEMENT FOR THE APPLICATION OF FLUIDS AND SYSTEM FOR THE APPLICATION OF FLUIDS

(71) Applicant: Illinois Tool Works Inc., Glenview, IL (US)

(72) Inventor: Andreas Pahl, Erkrath (DE)

(73) Assignee: Illinois Tool Works Inc., Glenview, IL (US)

(21) Appl. No.: 18/882,253

(22) Filed: Sep. 11, 2024

(30) Foreign Application Priority Data
Oct. 10, 2023 (DE) 10 2023 127 636.0

(51) Int. Cl. B05B 1/06; B05B 12/18

(52) U.S. Cl. CPC B05B 1/06; B05B 12/18

(57) ABSTRACT

A nozzle arrangement for applying fluids onto a substrate, the nozzle arrangement comprising a spray nozzle having a nozzle body extending in a longitudinal direction of the spray nozzle and a first fluid channel coaxially extending to the longitudinal axis of the nozzle body for the fluids to be applied onto the substrate. The spray nozzle also includes a nozzle housing in which the nozzle body is received. Second fluid channels are in regions between a lateral surface and an inner surface of the nozzle body for shaping air. The second fluid channels extend over their entire length in the longitudinal direction parallel to the first fluid channel and, at an end-side nozzle outlet region of the spray nozzle, are open into a tapered or conical gap that tapers towards a nozzle outlet opening of the nozzle body.

### CROSS-REFERENCE TO RELATED APPLICATIONS

This application claims priority to German Patent Application No. 10-2023-127-636.0 (filed 10 Oct. 2023), the entire disclosure of which is incorporated by reference.

### BACKGROUND

### Technical Field

The present invention relates generally to the application of fluids.

### Description Of Related Art

Document EP 0 872 580 A, for example, discloses a plurality of meltblowing nozzle arrangements or nozzles that can be fastened side by side at one or both ends of a conventional distributor or distributor head, which ensures a metered delivery of adhesive to each nozzle arrangement. Each nozzle arrangement comprises a plurality of substantially parallel plate elements, which form a row of adhesive-dispensing openings on an outlet surface. The row of fluid discharge openings of each nozzle arrangement forms a portion of a longer row formed by the plurality of adjacent nozzle arrangements disposed along a common end of the distributor head. One or both sides of the distributor can be fastened alongside a similarly constructed distributor head to form even longer rows of fluid discharge openings, thereby providing a modular meltblowing adhesive dispenser system that accommodates substrates of any dimensional width.

In some adhesive-dispensing applications, the adhesive is applied in such a way that it covers the entire width of the substrate, and in other applications it is desirable for the adhesive to be applied only to selected portions or regions of the substrate and to keep other portions or regions of the substrate free of adhesive. This is the case, for example, for applications in which an edgefold region of a substrate has to be provided with adhesive.

Edgefolding is the process of folding a material 90 degrees or 180 degrees around a part edge. The thus formed edgefold region is then often fastened to a carrier part by means of a suitable joining method, in particular adhesive bonding.

Such edgefolding processes are used in particular in the automotive industry for trim parts. The increasingly complicated three-dimensional geometries of the trim parts present a major challenge to the joining methods to be used. One problem in particular is applying an appropriate adhesive pattern uniformly and continuously in the edgefold regions with the aid of a nozzle arrangement guided by a robot arm.

In a schematic and isometric view, FIG. 1 shows a conventional system 50 for applying thermoplastic adhesives 20 to a substrate 21 comprising corresponding edgefold regions.

The system 50 according to FIG. 1 consists substantially of a distributor head 30, which preferably is or can be connected to a robot arm (not shown in FIG. 1) and which can be moved along a movement direction relative to the substrate 21. In a mounting region of the distributor head 30, a nozzle arrangement 101 is preferably interchangeably connected to the distributor head 30. The distributor head 30 serves to appropriately supply the nozzle arrangement 101 with the thermoplastic adhesive 20 to be sprayed and, optionally, with shaping air, etc.

The nozzle arrangement 101 used in the conventional system 50 to apply thermoplastic adhesives 20 to a substrate 21 comprises a base body 102, which, seen in plan view, is at least substantially rectangular and which is connected to the mounting region of the distributor head 30.

The base body of the nozzle arrangement 101 comprises a front-side lateral surface, via which thermoplastic adhesive 20 to be applied to the substrate 21 is dispensed with the outlet surface.

For this purpose, as indicated in FIG. 1, a discharge nozzle 105 is formed on the front-side lateral surface of the base body 102 of the nozzle arrangement 101, wherein the discharge opening of the discharge nozzle 105 is configured such that a main flow axis, which is defined by said discharge opening and along which the adhesive jet 20 dispensed by the discharge nozzle moves, encloses a right angle (90 degrees) with the front-side lateral surface of the base body 102.

The fundamental problem with this design of the nozzle arrangement 101 is that, when the distributor head 30 moves relative to the substrate 21 in the movement direction indicated in FIG. 1 by the arrow, due to the complex three-dimensional geometry of the substrate 21, there is a risk that either the distributor head 30 comes into contact with the substrate 21, or specific regions of the substrate 21, in particular regions in an edgefold region of the substrate 21, can no longer be reached by the nozzle arrangement 101.

Publication DE 23 56 229A1 relates to an atomizer nozzle having one or more passageways for the material to be atomized as well as for at least one propellant gas, which forms a gas vortex outside the atomizer nozzle. The atomizer nozzle known from this prior art is used in particular for spraying metal particles or for thin metallic coatings, and the like. The atomizer nozzle is configured so as to atomize the liquid comprising the metal particles to be sprayed and transfer it into a type of liquid veil.

For this purpose, DE 23 56 229A1 teaches that the fluid channels for the propellant gas are centrally offset at an end-side nozzle outlet region of the atomizer nozzle and are not arranged concentrically in order to rotate the liquid to be sprayed.

Although the atomizer nozzle known from DE 23 56 229A1 may be suitable, in principle, to spray the liquid with the metal particles in a sufficient manner for the generation of thin metallic coatings, this is not, or at least not directly, transferable for applications according to the present invention, in which thermoplastic adhesives are in particular to be transferred onto a substrate.

In particular, it has been shown that the principle known from DE 23 56 229A1 reacts particularly sensitively to parameter changes for uses involving the application of thermoplastic adhesives. With the approach known from DE 23 56 229 A1, an optimal atomization of the (in particular) thermoplastic adhesive is no longer possible, even with already minimal pressure changes of the propellant gas (in particular).

### BRIEF SUMMARY

The present invention relates generally to the application of fluids, including thermoplastic or fibrous adhesives, to a substrate by means of at least one nozzle arrangement which is, or can be, preferably detachably fastened to a mounting surface of a distributor or a distributor head, wherein said distributor or distributor head typically serves to deliver the fluid to be applied to the at least one nozzle arrangement.

The purpose of such a system is to apply fluids to substrates moving relative to the at least one nozzle arrangement, for example, and in particular to apply adhesives in partial spray patterns to partially cover a substrate.

### BRIEF DESCRIPTION OF THE SEVERAL VIEWS OF THE DRAWINGS

The invention is described in more detail below with reference to the accompanying drawings.

The following are shown:

FIG. 1 schematically and in an isometric view, a conventional system for applying thermoplastic adhesives to a substrate;

FIG. 2 schematically and in an isometric view, an exemplary embodiment of the system according to the invention for applying thermoplastic adhesives to a substrate;

FIG. 3 schematically and in an isometric view, a further exemplary embodiment of the system according to the invention for applying thermoplastic adhesives to a substrate;

FIG. 4 schematically and in an isometric exploded view, an exemplary embodiment of a spray nozzle for a nozzle arrangement used in the system according to the invention for applying thermoplastic adhesives to a substrate according to FIG. 2 or FIG. 3;

FIG. 5 schematically and in a longitudinal sectional view, an exemplary embodiment of the nozzle arrangement according to the invention for a system for applying thermoplastic adhesives to a substrate, in particular for a system according to FIG. 2 or FIG. 3;

FIG. 6 schematically and in a detail view, the end-side nozzle outlet region of the spray body of the nozzle arrangement according to FIG. 5; and

FIG. 7 schematically and in an isometric view, the exemplary embodiment of the system according to the invention according to FIG. 2 when applying a thermoplastic adhesive to a substrate.

### DETAILED DESCRIPTION OF THE INVENTION

Based on the previously stated problem, the underlying object of the invention is therefore to specify a nozzle arrangement for applying fluids, in particular thermoplastic adhesives, to a substrate, wherein the nozzle arrangement makes it possible to apply the thermoplastic adhesive or the fluid in a targeted manner in a sufficiently atomizing manner, even in the case of complicated geometries of the substrate and also in the event of deviating process parameters.

A correspondingly optimized system for applying fluids, in particular thermoplastic adhesives, to substrates having a correspondingly complex geometry is to be specified as well.

With regard to the nozzle arrangement, the underlying object of the invention is solved by the subject matter of independent claim 1, wherein advantageous further developments of the nozzle arrangement according to the invention are specified in the dependent claims 2 to 14.

With regard to the system, the underlying object of the invention is solved by the subject matter of the ancillary claim 15.

The present invention therefore relates in particular to a nozzle arrangement for applying fluids, in particular thermoplastic adhesives, to a substrate, wherein the nozzle arrangement comprises a spray nozzle which can preferably be used interchangeably with a mounting region of a distributor.

In order to ensure that the nozzle arrangement can be used to apply the thermoplastic adhesive or the fluid in a targeted manner even in the case of complicated geometries of the substrate, according to the invention it is in particular provided that the spray nozzle of the nozzle arrangement be configured as a relatively long finger spray nozzle having a relatively small diameter, to thus make it possible for the fluid (in particular the thermoplastic adhesive) to be applied in a targeted manner with the spray nozzle, even to regions of the substrate that are otherwise difficult to access.

In this context, a two-part structure of the spray nozzle is in particular provided for the design of the finger spray nozzle, wherein the spray nozzle comprises an in particular rod-shaped nozzle body which extends in the longitudinal direction of the spray nozzle as the first component and a nozzle housing as the second component, in which the nozzle body is or can be accommodated at least partly.

At least one first fluid channel, and preferably exactly one (single) first fluid channel, for the fluid to be applied to the substrate is formed in the in particular rod-shaped nozzle body. This preferably single first fluid channel extends in particular coaxially to the longitudinal axis of the in particular rod-shaped nozzle body.

The spray nozzle of the nozzle arrangement according to the invention is particularly preferably configured so as to dispense the fluid, and in particular the thermoplastic adhesive, at the end-side nozzle outlet region of the spray nozzle in an undiverted manner, in particular not in a spiral-shaped diverted manner, but rather as a full cone. In this context it is, in particular, desirable for the fluid to be dispensed at the end-side nozzle outlet region of the spray nozzle in as perfectly round a full cone as possible. The dispensing of the fluid at the end-side nozzle outlet region of the spray nozzle in the form of an atomized full cone has the crucial advantage that the nozzle arrangement does not always have to be aligned exactly in relation to the surface of the substrate when applying the fluid. When applying fluids in an edge fold region in particular, this is typically not possible, or possible only with a great deal of effort, because the shape of the substrate in edgefold regions is generally very complex and, when aligning the nozzle arrangement relative to the substrate, the nozzle arrangement has to continuously be realigned to take into account the complex shape of the edge fold region.

To create an atomized full cone of the fluid dispensed from the first fluid channel at the nozzle outlet region of the spray nozzle, the solution according to the invention makes use of suitable shaping air.

In this context, it is in particular provided that a plurality of second fluid channels for shaping air are formed at least in certain areas between an outer surface of the nozzle body and an inner surface of the nozzle housing of the spray nozzle.

The invention is characterized in particular in that the second fluid channels extend over their entire length in the longitudinal direction of the spray nozzle and parallel to the first fluid channel and, at an end-side nozzle outlet region of the spray nozzle, open into a tapered or conical gap, wherein the tapered or conical gap tapers towards a nozzle outlet opening of the nozzle body.

Thus, it can be achieved that, in an even manner, and in particular substantially at least independently of parameter changes, such as changes in the pressure of the shaping air, the fluid can be dispensed from the nozzle outlet opening of the nozzle body in an atomized full cone shape.

In other words, the end-side nozzle outlet region of the spray nozzle is configured in particular as a full-cone atomizer nozzle, with an internal mixture of the fluid to be applied to the substrate and of the shaping air.

It is provided in particular that the second fluid channels open in a straight line into the tapered or conical gap such that the shaping air dispensed by the second fluid channels is deflected only towards the nozzle outlet opening of the nozzle body, but not perpendicular to the longitudinal direction of the nozzle body.

In other words, unlike the nozzle arrangements known from the prior art, no spiral deflection of the fluid dispensed or to be dispensed from the nozzle outlet opening of the nozzle body takes place. Such a spiral deflection varies greatly in terms of the pressure and fluid velocity of the shaping air and is thus very sensitive to parameter changes.

Various embodiments come into question for the formation of the tapered or conical gap space at the end-side nozzle outlet region of the spray nozzle.

Particularly preferably, it is provided that at the end-side nozzle outlet region of the spray nozzle, the nozzle body is configured in a tapered or conical manner. Also at the end-side nozzle outlet region of the spray nozzle, the nozzle housing is designed to be tapered or conical, wherein the tapered or conical gap space is formed between the tapered or conical end region of the nozzle body on the one hand and the tapered or conical end region of the nozzle housing on the other hand.

Preferably, a distance between the tapered or conical outer surface of the end region of the nozzle body and the tapered or conical inner surface of the end region of the nozzle body is 0.1 mm to 0.4 mm, and preferably 0.2 mm to 0.3 mm. The distance is preferably constant.

In order to enable a particularly efficient atomization of the fluid supplied by the first fluid channel, it is provided according to implementations of the nozzle arrangement according to the invention that the first fluid channel opens into the tapered or conical gap space opposite the nozzle outlet opening of the nozzle body. This ensures that an internal mixture can be realized in the conical gap space.

According to preferred implementations of the nozzle arrangement according to the invention, it is provided that, at the end-side nozzle outlet region of the spray nozzle, at least the inner surface of the nozzle housing has a cone shape that tapers towards the nozzle outlet opening of the nozzle body and, in particular, is adapted to a cone shape of the nozzle body in such a way that two distanced hollow conical regions are formed between which the tapered conical regions are formed.

Preferably, at the end-side nozzle outlet region of the spray nozzle, the nozzle body has a shape that tapers towards the nozzle outlet opening of the nozzle body, in particular an at least substantially tapered or conical shape, with a taper or cone angle of preferably 30° to 120°, and in particular with a taper or cone angle of about 50° to about 100°.

Of course, however, other shapes of the nozzle body at the end-side nozzle outlet region of the spray nozzle are also conceivable.

According to preferred implementations of the nozzle arrangement according to the invention, it is provided that the nozzle housing is configured at least in certain areas as a sleeve-shaped body which at least partly surrounds the nozzle body.

The best option here is for the nozzle housing to be fastened or fastenable to a connecting region of a connecting body of the nozzle arrangement, preferably together with the nozzle body and in particular in a detachable and/or interchangeable manner.

According to preferred embodiments of the nozzle arrangement according to the invention, a squeeze screw connection at the connecting region of the connecting body effected via a union nut is used to fasten the nozzle housing with the nozzle body to the connecting region of the connecting body.

This embodiment has the crucial advantage that both the nozzle housing and the nozzle body can be removed from the connecting region of the connecting body by loosening the union nut. Loosening the union nut also loosens the connection between the nozzle housing and the nozzle body, so that the two components can be separately cleaned and/or serviced, or the two components can be replaced independently of one another.

Different configurations for forming the, in particular, rod-shaped nozzle body are possible.

According to preferred implementations of the nozzle arrangement according to the invention, it is in particular provided that the at least exactly one first fluid channel, which extends in particular coaxially to the longitudinal axis of the nozzle body, is configured as a through-bore in the rod-shaped nozzle body.

The best option for forming the second fluid channels is for the in particular rod-shaped nozzle body to have a polygonal cross-sectional profile at least in certain areas. When the rod-shaped nozzle body with the polygonal cross-sectional profile is accommodated in the nozzle housing, the individual second fluid channels are formed in the region of the surfaces of the polygonal cross-sectional profile.

According to preferred implementations of the rod-shaped nozzle body, said nozzle body in particular has a hexagonal cross-sectional profile with a diameter of 6 mm to 10 mm and a key face dimension of the hexagon between 5 mm and 9 mm.

As a result of the hexagonal cross-sectional profile, a total of six second fluid channels are formed in such a rod-shaped nozzle body when the rod-shaped nozzle body is accommodated in the nozzle housing.

It is generally advantageous for the diameter of the rod-shaped nozzle body to be in a range from 6 mm to 12 mm and preferably in a range from 6 mm to 10 mm. These dimensions make it possible to create a particularly “slim” finger spray nozzle.

As an alternative to the last-mentioned embodiment, it is conceivable for the in particular rod-shaped nozzle body to at least in certain areas have an at least substantially circular-cylindrical cross-sectional profile, wherein groove regions extending parallel to the longitudinal axis of the nozzle body are formed in the outer surface of the circular-cylindrical nozzle body to form the second fluid channels.

In order to achieve as perfect and in particular as even an atomization as possible of the fluid dispensed at the end-side nozzle outlet region of the spray nozzle via the first fluid channel, the second fluid channels should be configured evenly spaced, and in particular equidistant with respect to one another, over the outer surface of the nozzle body.

According to implementations of the nozzle arrangement according to the invention, it is provided that, at least in the region in which it is held in the nozzle housing, the nozzle body is configured at least partly as a substantially cylindrical nozzle body, wherein groove regions extending in the longitudinal direction of the spray nozzle and/or regions extending in the longitudinal direction of the spray nozzle and recessed with respect to the outer surface of the cylindrical body, are formed in said substantially cylindrical nozzle body, which, together with the inner surface of the nozzle housing, delimit the second fluid channels at least partly.

Of course, other embodiments for the nozzle body are possible here as well.

According to a further aspect of the present invention, it is provided that at least the inner surface of the nozzle housing on the end-side nozzle outlet region of the spray nozzle has a conical shape which tapers in the direction of the nozzle outlet opening of the nozzle body and in particular matches a conical shape of the nozzle body.

This aspect is a particularly easy-to-implement but nevertheless effective measure to achieve as perfect a tapered shape and atomization as possible of the fluid dispensed from the first fluid channel at the nozzle outlet opening of the nozzle body.

In this context, it is advantageous that groove and/or recess regions are formed in the nozzle body on the end-side nozzle outlet region of the spray nozzle, each of which is fluidically connected to one of the second fluid channels. The shaping air transported by the second fluid channels can thus be delivered in a targeted manner to the end-side nozzle outlet region of the spray nozzle.

At the end-side nozzle outlet region of the spray nozzle, the nozzle body preferably has a conical shape which tapers in the direction of the nozzle outlet opening of the nozzle body with a cone angle of preferably 30 degrees to 120 degrees and in particular with a cone angle of preferably 50 degrees to 100 degrees.

According to preferred implementations of the spray nozzle according to the invention, seen in the longitudinal direction of the spray nozzle, the nozzle body has a length of 20 mm to 100 mm and preferably a length of 30 mm to 80 mm, and even more preferably a length of 40 mm to 60 mm.

Alternatively or additionally, it is advantageous if the nozzle body with the nozzle housing has a maximum average diameter of 20 mm and preferably a maximum average diameter of 15 mm. It is thus possible to create particularly slim finger spray nozzles with the solution according to the invention.

According to a further aspect of the present invention, it is provided that, when the spray nozzle is mounted on the connecting region of the connecting body, a preferably ring-shaped region is formed in a region between the connecting body and the spray nozzle and, on the one hand, is fluidically connected to a source for shaping air, in particular with a compressed air, and, on the other hand, is fluidically connected to the second fluid channels of the spray nozzle.

Providing such a preferably ring-shaped region at the connecting region of the connecting body ensures that a preferably equal and constant quantity of shaping air is fed into each second fluid channel per unit of time.

According to a further development of the aforementioned aspect, it is in particular provided that a seal, in particular in the form of a sealing ring, is associated with the nozzle body in order to separate the in particular ring-shaped region for shaping air and a region, which is preferably arranged axially with respect to the longitudinal axis of the nozzle body and via which the fluid to be applied to the substrate can be fed into the first fluid channel of the spray nozzle.

The invention further relates to the use of the aforementioned nozzle arrangement according to the invention to apply a fluid, in particular thermoplastic adhesive, to an edgefold region of a component.

The invention also relates to a system for applying fluids, in particular thermoplastic adhesives, to a substrate, wherein the system comprises a distributor head, which can be moved along a movement direction relative to the substrate. The distributor head preferably is or can be connected to a robot arm.

The system furthermore comprises at least one nozzle arrangement of the type according to the invention described above, which is preferably interchangeably connected to the distributor head in a mounting region of the distributor head.

The nozzle arrangement according to the invention in particular makes it possible for even complex geometric regions of the substrate, in particular, to effectively reach the region of the nozzle outlet opening of the spray nozzle when the fluid is applied to the substrate, without the occurrence of contact between the nozzle arrangement or the distributor or distributor head and the substrate.

The invention further relates to a method for applying fluids, in particular thermoplastic adhesives, to a substrate, for which purpose a nozzle arrangement is moved relative to the substrate in a movement direction, wherein the nozzle arrangement is in particular a nozzle arrangement of the type according to the invention described above.

In the application method according to the invention, a fluid jet is furthermore dispensed through the nozzle outlet opening of the nozzle body of the nozzle arrangement, namely in particular during the movement of the nozzle arrangement relative to the substrate.

In this regard, it is in particular provided that the fluid jet dispensed through the nozzle outlet opening of the nozzle body is preferably deflected with the aid of shaping air, in particular to create a specified pattern of the fluid jet to be applied to the substrate.

The substrate is advantageously a component with an edgefold region, wherein the nozzle arrangement is moved at least partly into the edgefold region of the substrate as the fluid jet is being dispensed through the nozzle outlet opening of the nozzle body.

It has long been recognized that thermoplastic adhesives constitute good binding agents. This is because they harden quickly, which is particularly advantageous when the adhesive is applied incrementally and the joining of the parts to be bonded is then immediate, and the obtained adhesive bond is very strong. The range of components of which thermoplastic adhesives can be composed is moreover so extensive that an appropriate adhesive composition can easily be produced for any given purpose.

Nevertheless, certain difficulties have stood in the way of the widespread use of these adhesives insofar as the thermoplastic adhesive sometimes cannot be applied in an automated manner to specific, selected regions of a substrate, in particular those having a complex geometry, or can only be applied with great difficulty. This applies in particular to edgefold regions of substrates formed as molded bodies.

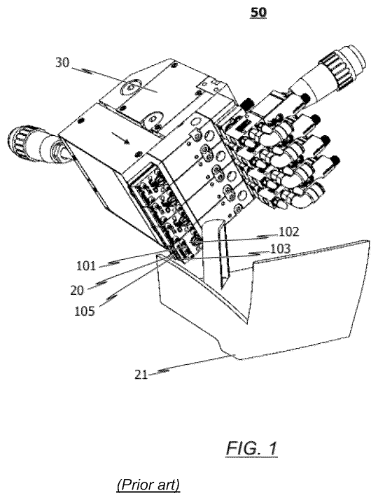

FIG. 1 shows schematically and in an isometric view a conventional system 50, by means of which a thermoplastic adhesive 20 is applied in an automated manner to specific regions of a substrate formed as a molded part. The conventional system 50 for applying thermoplastic adhesives 20 to a substrate 21 formed as a molded body comprises a distributor head 30, which preferably is or can be connected to a robot arm not shown in FIG. 1 and which can be moved along a movement direction relative to the substrate 21 with the aid of said robot arm.

As shown in FIG. 1, the conventional system 50 for applying thermoplastic adhesives further comprises a nozzle arrangement 101, which is preferably interchangeably connected to the distributor head 30 in a mounting region of the distributor head 30. The nozzle arrangement 101 is formed substantially by an approximately rectangular base body 102, via which the nozzle arrangement 101 is connected to the mounting region of the distributor head 30. This base body 102 of the nozzle arrangement 101, which is substantially rectangular when viewed from above, comprises a front-side lateral surface 103 in which a discharge nozzle 105 is formed. The main flow axis defined by the discharge nozzle 105 or the discharge opening of the discharge nozzle 105, along which the thermoplastic adhesive material 20 dispensed by the discharge nozzle 105 moves, encloses an at least substantially right angle with the front-side lateral surface 103 of the base body 102 of the nozzle arrangement 101. The front-side lateral surface 103 of the base body 102 is furthermore in the movement direction of the distributor.

In applications of the conventional system 50 for molded parts having complex geometric structures and in particular comprising edgefold regions, it is typically unavoidable that either parts of the system, in particular the distributor head or the nozzle arrangement, come into contact with regions of the molded part or that not all necessary regions of the molded part can be reached with the nozzle arrangement.

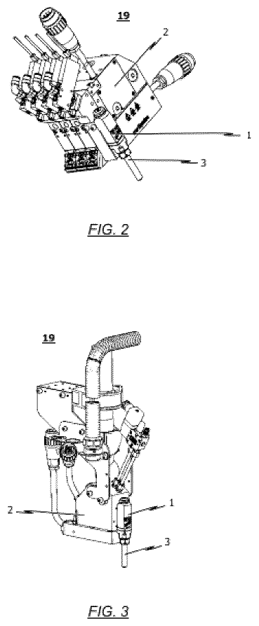

To solve this problem, the invention proposes an optimized nozzle arrangement 1, wherein exemplary embodiments of said nozzle arrangement 1 are described in more detail in the following with reference to the illustrations in FIG. 2 to FIG. 12.

More specifically, in a schematic and isometric view, FIG. 2 shows an exemplary embodiment of the system 19 according to the invention, wherein said system 19 is used to apply fluids 20, in particular thermoplastic adhesives, to a substrate 21, and wherein said system 19 substantially comprises a distributor head 2, which preferably is or can be connected to a robot arm and which can be moved along a movement direction relative to the substrate 21 (not shown in FIG. 2).

The system 19 schematically shown in FIG. 2 furthermore comprises a nozzle arrangement 1, which is preferably interchangeably connected to the distributor head 2 in a mounting region of the distributor head 2.

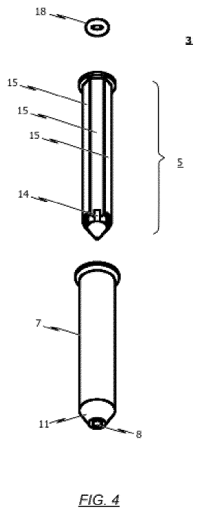

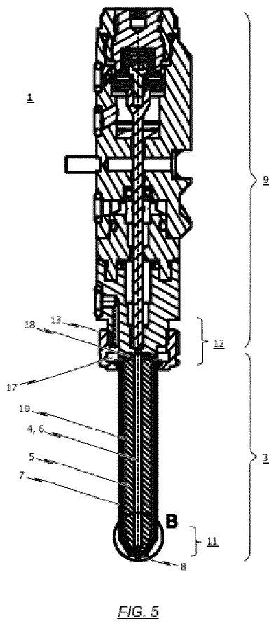

The structure and the mode of operation of the nozzle arrangement 1 used in the system 19 shown schematically in FIG. 2 are described in more detail in the following with reference to the illustrations in FIG. 4 to FIG. 6.

In a schematic and isometric view, FIG. 3 shows an alternative embodiment of the system 19 according to the invention for applying fluids 20 to a substrate 21 (likewise not shown in FIG. 3). The exemplary embodiment of the system 19 according to the invention shown schematically in FIG. 3 differs from the system 19 shown schematically in FIG. 2 primarily in the structure of the distributor head 2 to which the nozzle arrangement 1 according to the invention is connected.

An exemplary embodiment of the nozzle arrangement 1 according to the invention or the spray nozzle 3 of said nozzle arrangement 1 according to the invention are described in more detail in the following with reference to the illustrations in FIG. 4 to FIG. 6.

The nozzle arrangement 1 is used to apply fluids 20, in particular thermoplastic adhesives, to a substrate 21, wherein the nozzle arrangement 1 comprises a connecting body 9 which can be preferably interchangeably connected to a mounting region of a distributor 2 and a spray nozzle 3 which can be preferably interchangeably connected to said connecting body 9.

As is in particular evident from the exploded view in FIG. 4, the spray nozzle 3 according to the invention has a substantially two-part structure and consists of an in particular rod-shaped nozzle body 5 which extends in the longitudinal direction 4 of the spray nozzle 3 and a nozzle housing 7. The nozzle housing 7 comprises a sleeve-shaped base body.

A first fluid channel 6 for the fluid 20 to be applied to the substrate 21 is formed in the rod-shaped nozzle body 5. In this regard, reference is made in particular to the sectional view in FIG. 4. The first fluid channel 6 extends in particular coaxially to the longitudinal axis of the (rod-shaped) nozzle body 5.

A plurality of second fluid channels 10 are formed between the outer surface of the rod-shaped nozzle body 5 and the inner surface of the in particular partially sleeve-shaped nozzle housing 7, and serve to supply shaping air to the end-side nozzle outlet region 11 of the spray nozzle 3. The shaping air delivered with the aid of the second fluid channels 10 in particular serves to effect an atomization of the fluid 20 dispensed or to be dispensed from the nozzle outlet opening 8 at the nozzle outlet opening 8 of the nozzle body 5.

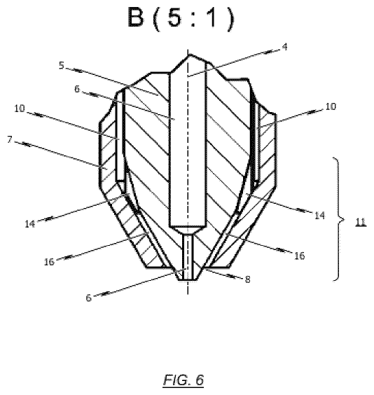

More specifically, and as is evident in particular from the sectional view in FIG. 5, for example, the nozzle housing 7 of the spray nozzle 3 is configured at least partly as a sleeve-shaped body which at least in certain areas surrounds the (rod-shaped) nozzle body 5. It is in particular provided that the nozzle housing 7 can be fastened, preferably together with the nozzle body 5, to the connecting region 12 of the connecting body 9, in particular in a detachable and/or interchangeable manner, namely with the aid of a squeeze screw connection on the connecting region 12 of the connecting body 9 effected by means of a union nut 13.

On the other hand, at least in the region in which it is held in the nozzle housing 7, the (in particular rod-shaped) nozzle body 5 is configured at least partly as a substantially cylindrical nozzle body 6, wherein groove regions or alternatively (as indicated in FIG. 4) extending in the longitudinal direction 4 of the spray nozzle 3, or regions 15 extending in the longitudinal direction 4 of the spray nozzle 3 and recessed with respect to the outer surface of the cylindrical nozzle body 5, are formed in said substantially cylindrical nozzle body 5. Together with the inner surface of the nozzle housing 7, these regions (groove regions or recessed regions 15) delimit the individual second fluid channels 10 of the spray nozzle 3 at least partly.

In the exemplary embodiment of the nozzle arrangement 1 according to the invention shown in FIG. 4 to FIG. 6, it is specifically provided that the rod-shaped nozzle body 5 has a polygonal cross-sectional profile at least in certain areas in order to form the corresponding second fluid channels 10 over the surface regions 15 of the polygonal cross-sectional profile (and the inner surface of the nozzle housing 7).

More specifically, in the embodiment according to FIG. 4 to FIG. 6 it is provided that the in particular rod-shaped nozzle body 5 has a hexagonal cross-sectional profile, at least in certain areas, in order to form in this manner a total of six second fluid channels 10 together with the nozzle housing 7.

According to preferred implementations, it is provided in this context that the diameter of the rod-shaped nozzle body 5 is preferably in a range from approx. 6 mm to approx. 12 mm and particularly preferably in a range from approx. 6 mm to approx. 10 mm.

In the case of the hexagonal cross-sectional profile shape of the rod-shaped nozzle body 5, which can be seen in particular in FIG. 4, the diameter of the rod-shaped nozzle body 5 is in particular approx. 6 mm to approx. 10 mm with a key face dimension of the hexagon between 5 mm and 9 mm.

As an alternative to such a polygonal cross-sectional profile of the rod-shaped nozzle body 5, it is conceivable for the nozzle body 5 of the spray nozzle 3 to at least in certain areas have a substantially circular-cylindrical cross-sectional profile, wherein groove regions (not shown in the illustrations) extending parallel to the longitudinal axis of the nozzle body 5 are formed in the outer surface of the circular-cylindrical nozzle body 5 to form the second fluid channels 10.

Independent of the question of how the second fluid channels 10 are ultimately formed, the second fluid channels 10 should be configured evenly spaced and in particular equidistant with respect to one another over the outer surface of the nozzle body 5, in order to be able to effect the best possible atomization of the fluid dispensed from the nozzle outlet opening 8 of the nozzle body 5 at the nozzle outlet region 11.

For this purpose, it is provided according to the invention that the second fluid channels 10 extend over their entire length in the longitudinal direction 4 of the spray nozzle 3 parallel to the first fluid channel 5 and, at an end-side nozzle outlet region 11 of the spray nozzle 3, open into a tapered or conical gap 16, wherein the tapered or conical gap 16 tapers, preferably uniformly, towards the nozzle outlet opening 8 of the nozzle body 5.

The end-side nozzle outlet region 11 of the spray nozzle 3 is configured in particular as a full-cone atomizer nozzle, preferably with an internal mixture of the fluid 20 to be applied to the substrate 21 and of the shaping air.

It can be seen from the illustration in FIG. 6 that the second fluid channels 10 open in a straight line into the tapered or conical gap 16 such that the shaping air dispensed by the second fluid channels 10 is deflected only towards the nozzle outlet opening 8 of the nozzle body 5, but not perpendicular to the longitudinal direction 4 of the spray nozzle 3.

It can likewise be seen that, at the end-side nozzle outlet region 11 of the spray nozzle 3, the nozzle body 5 is configured in a tapered or conical manner, and wherein, likewise at the end-side nozzle outlet region 11 of the spray nozzle 3, the nozzle housing 7 is configured in a tapered or conical manner, wherein the tapered or conical gap space 16 is formed between the tapered or conical end region of the nozzle body 5 on the one hand and the tapered or conical end region of the nozzle housing 7 on the other hand.

A tapered or conical outer surface of the end region of the nozzle body 5 and a tapered or conical inner surface of the end region are respectively designed without contours in a macroscopic region.

A distance between the tapered or conical outer surface of the end region of the nozzle body 5 and the tapered or conical inner surface of the end region of the nozzle housing is 0.1 mm to 0.4 mm and preferably 0.2 mm to 0.3 mm.

It can further be seen from the picture in FIG. 6 that the first fluid channel 6 opens into the tapered or conical gap 16 opposite the nozzle outlet opening 8 of the nozzle body 5.

At the end-side nozzle outlet region 11 of the spray nozzle 3, the nozzle body 5 has a tapered or conical shape which tapers in the direction of the nozzle outlet opening 8 of the nozzle body 5 with a taper angle or conical angle of preferably 30° to 120° and in preferably with a taper angle or conical angle of 50° to 100° degrees. In this context, reference is made in particular to the detail view in FIG. 6.

Similarly, in the nozzle arrangement 1 as shown in FIG. 4 to FIG. 6, it is provided that at least the inner surface of the nozzle housing 7 at the end-side nozzle outlet region 11 of the spray nozzle 3 has a shape that tapers towards the nozzle outlet opening 8 of the nozzle body 5 and is in particular a tapered or conical shape.

From the detail view in FIG. 6, it can be seen that, at the end-side nozzle outlet region 11 of the spray nozzle 3 on the at least substantially conical outer surface of the nozzle body 5, a spacer region 14 is preferably molded onto the nozzle body 5, namely such that, between the nozzle body 5 and the nozzle housing 7, the tapered/conical gap space 16 is formed, via which atomization of the fluid 20 to be delivered or dispensed from the nozzle outlet opening 8 of the nozzle body 5 is effected with the aid of the shaping air dispensed by the second fluid channels 10 at the nozzle outlet region 11.

In the sectional view in FIG. 5, it can be seen that, when the spray nozzle 3 is mounted on the connecting region 12 of the connecting body 9, a preferably ring-shaped region 17 is formed in a region between the connecting body 9 and the spray nozzle 3 and, on the one hand, is fluidically connected to a source for shaping air, in particular with a compressed air source (not shown in FIG. 5), and, on the other hand, is fluidically connected to the second fluid channels 10 of the spray nozzle 3.

The sectional view according to FIG. 5 also shows that a seal 18, in particular in the form of a sealing ring, is associated with the nozzle body 5 in order to separate the in particular ring-shaped region 17 for shaping air and a region, which is preferably arranged axially with respect to the longitudinal axis of the nozzle body 5 and via which the fluid to be applied to the substrate 21 is fed into the first fluid channel 6 of the spray nozzle 3.

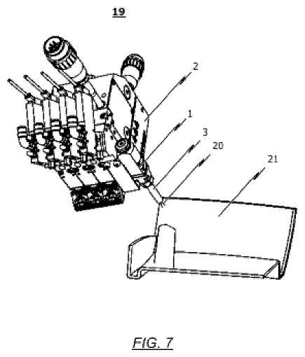

The invention further relates to the use of the nozzle arrangement 1 according to the invention for applying a fluid, in particular thermoplastic adhesive, to an edgefold region of a component, as shown schematically and in an isometric view in FIG. 7.

With the aid of the second fluid channels 10, shaping air (compressed air) is directed in the direction of the thermoplastic adhesive jet dispensed from the end-side nozzle outlet region 11 of the spray nozzle 3 in order to suitably deflect the adhesive jet 20.

The invention is not limited to the exemplary embodiment shown in the drawings, but rather results when all of the features disclosed herein are considered together.

1. A nozzle arrangement for applying fluids onto a substrate, the nozzle arrangement comprising:
a terminal body connected to a mounting region of a manifold; and
a spray nozzle connected to the terminal body, the spray nozzle comprising a nozzle body extending in a longitudinal direction of the spray nozzle and having at least one first fluid channel, the at least one first fluid channel coaxially extending to a longitudinal axis of the nozzle body for the fluids to be applied onto the substrate, the spray nozzle further comprising a nozzle housing in which the nozzle body is received at least in regions, wherein a plurality of second fluid channels are between a lateral surface of the nozzle body and an inner surface of the nozzle housing, the second fluid channels configured for shaping air,
wherein the second fluid channels extend over an entire length of the second fluid channels parallel to the at least one first fluid channel and the second fluid channels open into a tapered or conical gap that tapers toward a nozzle outlet opening of the nozzle body.

2. The nozzle arrangement according to claim 1, wherein the spray nozzle includes an end-side nozzle outlet region that is configured as a full-cone atomizer nozzle.

3. The nozzle arrangement according to claim 1, wherein the second fluid channels open in a straight line into the tapered or conical gap and deflect such that the air dispensed by the second fluid channels is deflected only toward the nozzle outlet opening of the nozzle body but not perpendicular to the longitudinal direction of the spray nozzle.

4. The nozzle arrangement according to claim 1, wherein, at an end-side nozzle outlet region of the spray nozzle, the nozzle body is configured in a tapered or conical manner, and wherein, at the end-side nozzle outlet region of the spray nozzle, the nozzle housing is configured in the tapered or conical manner, wherein the tapered or conical gap is formed between a first tapered or conical end region of the nozzle body and a second tapered or conical end region of the nozzle housing.

5. The nozzle arrangement according to claim 4, wherein a tapered or conical outer surface of the end region of the nozzle body and a tapered or conical inner surface of the end region of the nozzle housing are respectively designed without contours in a microscopic sense.

6. The nozzle arrangement according to claim 4, wherein a distance between a tapered or conical outer surface of the first tapered or conical end region of the nozzle body and the tapered or conical inner surface of the second tapered or conical end region of the nozzle housing is 0.1 mm to 0.4 mm.

7. The nozzle arrangement according to claim 4, wherein the at least one first fluid channel opens into the tapered or conical gap opposite the nozzle outlet opening of the nozzle body.

8. The nozzle arrangement according to claim 4, wherein the nozzle body has a shape that tapers toward the nozzle outlet opening of the nozzle body at an end-side nozzle outlet region of the spray nozzle.

9. The nozzle arrangement according to claim 8, wherein at least one region is integrally formed with the nozzle body at the end-side nozzle outlet region of the spray nozzle on a tapered or conical outer surface of the nozzle body.

10. The nozzle arrangement according to claim 1, wherein the nozzle housing is configured, at least partly, as a sleeve-shaped body, which surrounds the nozzle body, at least partly.

11. The nozzle arrangement according to claim 1, wherein the nozzle body is rod-shaped and has, at least in regions, a multi-edged cross-sectional profile.

12. The nozzle arrangement according to claim 1, wherein the second fluid channels are uniform in relation to one another over a lateral surface of the nozzle body and are equidistant to one another.

13. The nozzle arrangement according to claim 1, wherein the nozzle body is configured as a substantially cylindrical nozzle body at least in regions in which the nozzle body is received in the nozzle housing, wherein one or more of: groove regions extend the nozzle body in the longitudinal direction of the spray nozzle or recessed regions are formed in the nozzle body and extend in the longitudinal direction of the spray nozzle and are recessed with respect to the lateral surface of the nozzle body.

14. The nozzle arrangement according to claim 1, wherein the nozzle body, when viewed in the longitudinal direction of the spray nozzle, has a length between about 20 mm and about 100 mm.

15. A system for applying fluids onto a substrate, the system comprising:
a distributor head movable along a direction of movement relative to the substrate; and
at least one of the nozzle arrangement according to claim 1.

16. The nozzle arrangement according to claim 2, wherein the end-side nozzle outlet region is configured as the full-cone atomizer nozzle with an internal mixture of the fluid to be applied to the substrate and the air that is shaped.

17. The nozzle arrangement according to claim 9, wherein the at least one region is integrally formed with the nozzle body such that the tapered or conical gap is formed between the nozzle body and the nozzle housing.

18. The nozzle arrangement according to claim 10, wherein the nozzle housing is fastened in a detachable or exchangeable manner with the nozzle body at a terminal region of the terminal body with a squeeze connection produced by a swivel nut at the terminal region of the terminal body.

19. The nozzle arrangement according to claim 11, wherein the regions are first regions, and the nozzle body has a hexagonal cross-sectional profile in at least second regions.

20. The nozzle arrangement according to claim 14, wherein when the spray nozzle is mounted on a terminal region of the terminal body, an annular region is formed between the terminal body and the spray nozzle.
